(19) United States
(12) Patent Application Publication
(10) Pub. No.: US 2016/0041788 A1
(43) Pub. Date: Feb. 11, 2016

(54) METHOD OF OPTIMIZING NON-VOLATILE MEMORY BASED STORAGE DEVICE

(71) Applicant: SAMSUNG ELECTRONICS CO., LTD., Suwon-si (KR)

(72) Inventors: JOON HO LEE, Hwaseong-si (KR); Jong Tae Park, Hwaseong-si (KR)

(21) Appl. No.: 14/812,489

(22) Filed: Jul. 29, 2015

(30) Foreign Application Priority Data
Aug. 5, 2014 (KR) 10-2014-0100548

(51) Int. Cl. G06F 3/06

(52) U.S. Cl. CPC G06F 3/0634; G06F 3/0604; G06F 3/0673

(57) ABSTRACT

A method of optimizing a non-volatile memory based storage device is provided. The method includes requesting state information from the storage device; analyzing the state information received in response to the requesting to determine at least one recommended use for the storage device; displaying the at least one recommended use to a user to enable the user to select a recommended use; setting a configuration corresponding to the selected use; and issuing a configuration change request to the storage device to configure the storage device with the set configuration.

### CROSS-REFERENCE TO RELATED APPLICATIONS

This application claims priority under 35 U.S.C. §119(a) to Korean Patent Application No. 10-2014-0100548 filed on Aug. 5, 2014, the disclosure of which is incorporated by reference in its entirety herein.

### BACKGROUND

1. Technical Field

Embodiments of the inventive concept relate to a storage device, and more particularly, to a non-volatile memory based storage device and a method of optimizing the same.

2. Discussion of Related Art

Storage devices, such as secure digital (SD) cards or solid state drives (SSDs), formed with non-volatile memory (e.g., flash memory) have no choice but to be used with an initial configuration set when sold. Software for storage devices is designed to operate in the same manner all the time regardless of the purposes of the storage devices.

Conventionally, once a storage device is purchased, it is impossible to optimize the storage device for the purpose of use.

### SUMMARY

Some embodiments of the inventive concept provide a method of optimizing a storage device allowing a user to easily change or optimize the configuration of the storage device for the purpose of use.

According to an exemplary embodiment of the inventive concept, there is provided a method of optimizing a storage device including a non-volatile memory using an application program of a host. The method includes the application program requesting state information from the storage device; the application analyzing the state information received in response to the requesting to determine at least one recommended use for the storage device; the application program displaying the at least one recommended use to a user to enable the user to select a recommended use; the application program setting a configuration corresponding to the selected use; and the application program issuing a configuration change request to the storage device to configure the storage device with the set configuration.

The method may further include storing predetermined configuration information for each of a plurality of uses.

The method may further include receiving the configuration information for each of the uses from a server through a network.

The configuration change request may include at least one vendor specific command.

According to an exemplary embodiment of the inventive concept, there is provided a method of optimizing a storage device including a non-volatile memory using an application program of a host. The method includes the application program storing configuration information for each of a plurality of uses of the storage device; the application program displaying a subset of the users to a user to enable the user to select a use; the application program selecting a configuration corresponding to the selected use from among the configuration information; the application program issuing a configuration change request to the storage device according to the selected configuration; and the storage device changing configuration of the non-volatile memory in response to the configuration change request.

The method may further include the application program requesting state information from the storage device. The subset may be determined based on the state information.

The method may further include the application program displaying at least one recommended operation to the user based on the state information and the application program issuing an operation execution command to the storage device when one of the at least one recommended operation displayed is selected by the user.

According to an exemplary embodiment of the inventive concept, there is provided a method for reconfiguring a non-volatile memory (NVM). The method includes the NVM sending state information of the NVM in response to receipt of a first command requesting state information and the NVM adjusting its configuration to a configuration optimized for a host type of a type in response to receipt of a second command requesting configuration of the NVM for the type.

The second command may enable or disable an LSB backup of the NVM, may change a ratio of a non-user area of the NVM to an entire memory area of the NVM, may change a mapping mode of the NVM to one of a page mapping mode, a block mapping mode, and a hybrid mapping mode, or may configure memory cells of the NVM to one of single level cells and multi-level cells.

### BRIEF DESCRIPTION OF THE DRAWINGS

The inventive concept will become more apparent by describing in detail, exemplary embodiments thereof with reference to the attached drawings in which:

FIG. 1 is a block diagram of an electronic system according to an exemplary embodiment of the inventive concept;

FIG. 2 is a block diagram of an electronic system according to an exemplary embodiment of the inventive concept;

FIG. 3 is a schematic diagram of a software layer in the electronic system illustrated in FIG. 2;

FIG. 4 is a block diagram of an electronic system according to an exemplary embodiment of the inventive concept;

FIG. 5 is a schematic block diagram of a storage device according to an exemplary embodiment of the inventive concept;

FIG. 6 is a flowchart of a method of optimizing a storage device according to an exemplary embodiment of the inventive concept;

FIGS. 7A through 7E are diagrams of display screens of an optimization application according to an exemplary embodiment of the inventive concept;

FIG. 8 is a flowchart of a method of optimizing a storage device according to an exemplary embodiment of the inventive concept;

FIG. 9 is a flowchart of a method of optimizing a storage device according to an exemplary embodiment of the inventive concept;

FIG. 10 is a flowchart of a method of optimizing a storage device according to an exemplary embodiment of the inventive concept; and

FIG. 11 is a flowchart of operations when defragmentation is selected in the method illustrated in FIG. 10.

### DETAILED DESCRIPTION

The inventive concept now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. As used herein, the singular forms “a”, “an” and “the” are intended to include the plural forms as well, unless the context clearly indicates otherwise.

A user can change a use of a storage device, and more particularly, a removable external storage device after purchasing it. In other words, the user can change a type of a host in which the storage device is installed. For instance, an external storage device such as a secure digital (SD) card can be used in various hosts such as a digital still camera (DSC), a digital video camera (DVC), a smart phone, and a black box. These hosts have different requirements and different input/output patterns. However, the user is neither allowed to optimize the SD card for each use after purchasing it nor allowed to check the state of the storage device and optimize the state during the use of the storage device. Although a WINDOWS operating system (OS) provides a function that performs a defragmentation of a file system, such a function is mostly performed in an OS or file system and is thus limited in its ability to optimize a storage device.

At least one embodiment of the inventive concept provides a method that allows a user to optimize a storage device directly. In particular, at least one embodiment of the inventive concept provides a new method of optimizing a storage device by allowing information to be transmitted between application software (i.e., an application program) and the storage device using the application software.

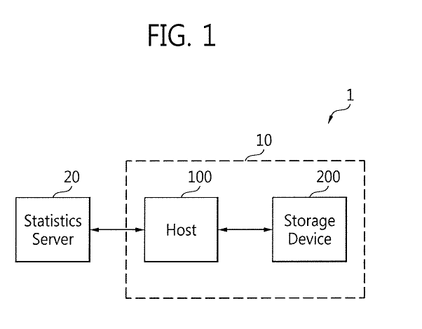

FIG. 1 is a block diagram of connections of an electronic system 10 according to an exemplary embodiment of the inventive concept. The electronic system 10 includes a host 100 and a storage device 200. The storage device 200 may be an external storage device connected to the host 100, but the inventive concept is not restricted to this example.

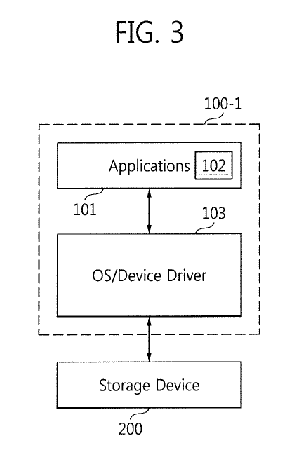

In an exemplary embodiment, the host 100 executes an application program, i.e., an optimization application (102 in FIG. 3) that can change or optimize the configuration of the storage device 200. The storage device 200 may be purchased by a user and have a basic configuration set at the time of shipment. After the storage device 200 is purchased or while it is being used, its configuration can be changed or optimized by the optimization application.

The host 100 may be connected to a statistics server 20 through a network. The host 100 may transmit information about the storage device 200, e.g., device information and state information, from the storage device 200 to the statistics server 20.

The statistics server 20 may receive and analyze the information about the storage device 200. Although not shown, the statistics server 20 may receive and collect information about many storage devices from many hosts and analyze the information so as to detect characteristics for each use of the storage device 200. In addition, the statistics server 20 may store configuration information predetermined for each use.

The statistics server 20 may analyze the state information of the storage device 200 received from the host 100, determine an optimal use of the storage device 200 based on the state information, and inform the host 100 of the determined optimal use. In addition, the statistics server 20 may provide configuration information corresponding to the determined optimal use for the host 100.

The statistics server 20 may collect and analyze information of many storage devices, so that it may change or update initial configuration information for each use. Alternatively, the host 100 may store configuration information predetermined for each use. For instance, the host 100 may receive configuration information from the statistics server 20 and store it and when the configuration information is updated in the statistics server 20, it may receive the updated configuration information and change the stored configuration information. As another alternative, the host 100 may directly analyze the information of the storage device 200, determine an optimal use for the current state of the storage device 200, and set configuration suitable for the optimal use.

In other words, a function of analyzing state information of the storage device 200, a function of determining an optimal use for the current state of the storage device 200 based on the analyzed state information, and a function of setting a configuration suitable for the optimal use may be performed by either the host 100 or the statistics server 20 or performed by both the host 100 and the statistics server 20 in a distributed fashion.

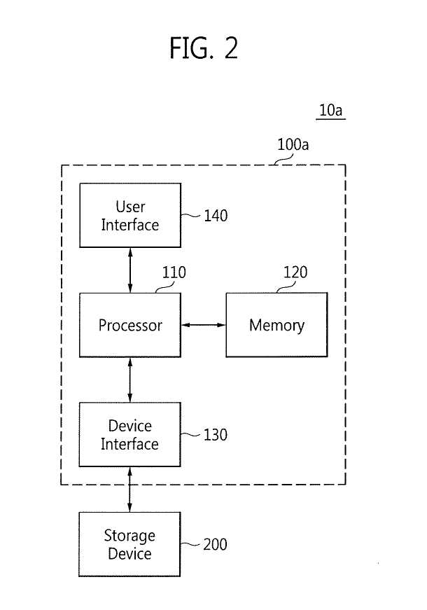

FIG. 2 is a block diagram of an electronic system 10a according to an exemplary embodiment of the inventive concept. Referring to FIG. 2, the electronic system 10a includes a host 100a and the storage device 200. The host 100a includes a processor 110, a memory 120, a device interface 130, and a user interface 140.

The processor 110 may control the overall operation of the host 100a. The processor 110 may be implemented as a system-on-chip (SoC). The processor 110 may be a general-purpose processor or a special-purpose processor.

The memory 120 may be an operation memory of the processor 110. The memory may store codes and data driven by the processor 110. The codes may be executable. The memory 120 may include read-only memory (ROM) and random access memory (RAM). The RAM may be formed with volatile RAM such as dynamic RAM (DRAM), static RAM (SRAM), or synchronous DRAM (SDRAM) or non-volatile RAM such as ferroelectric RAM (FRAM), phase-change RAM (PRAM), magnetic RAM (MRAM), or resistive RAM (RRAM).

The device interface 130 may relay communications between the processor 110 and the storage device 200. The device interface 130 may be integrated together with the processor 110 into a semiconductor integrated circuit, e.g., a SoC.

The storage device 200 may communicate with the processor 110 through the device interface 130. The storage device 200 may be accessed by the processor 110. The storage device 200 may be a non-volatile memory based storage device including non-volatile memory. The storage device 200 may include a storage device embedded in the host 100a, e.g., an embedded multimedia card (eMMC), and a storage device removable from the host 100a, e.g., an SD card, an MMC, or a solid state drive (SSD).

The user interface 140 may communicate with a user according to the control of the processor 110. The user interface 140 may include user input interfaces such as a keyboard, a keypad, a button, a touch panel, a touch screen, a touch pad, a touch ball, a microphone, and a sensor. The user interface 140 may include a device, such as a liquid crystal display (LCD) device, a light emitting diode (LED) display device, an organic LED (OLED) display device, an active-matrix OLED (AMOLED) display device, or a speaker, which outputs data or the like to a user.

The host 100a may include other elements besides the elements 110 through 140 illustrated in FIG. 2. For instance, the host 100a may also include a network device (not shown) and a camera module (not shown). The network device may connect the electronic system 10a to a wired or wireless network. The camera module may convert an optical image into an electrical image.

The electronic system 10a may be implemented as a personal computer (PC), a data server, or a portable electronic device. The portable device may be a laptop computer, a cellular phone, a smart phone, a tablet PC, a personal digital assistant (PDA), an enterprise digital assistant (EDA), a DSC, a DVC, a portable multimedia player (PMP), a personal navigation device or portable navigation device (PND), a handheld game console, or an e-book reader.

FIG. 3 is a schematic diagram of a software layer in the electronic system 10a illustrated in FIG. 2. Referring to FIGS. 2 and 3, the software layer includes applications 101, an OS/device driver 103, and the storage device 200.

The applications 101 are application programs that can be installed in and executed by the host 100a. The applications 101 include an optimization application 102.

The optimization application 102 may request and receive state information of the storage device 200 connected to the host 100a, process the state information into data that can be easily recognized by a user, and display the data. In addition, the optimization application 102 may analyze the state information of the storage device 200, determine an optimal use, i.e., recommend a use suitable for a current state, and set a configuration corresponding to the use by itself or in association with the statistics server 20.

In an exemplary embodiment, the optimization application 102 or the statistics server 20 estimates the performance, expected lifetime and/or data reliability of the storage device 200 based on the state information received from the storage device 200; compares the estimated information with statistics for each use, and determines a use best matching the estimated information as a recommended use. In an exemplary embodiment, the optimization application 102 or the statistics server 20 estimates the expected lifetime of the storage device 200 and/or used places (or environments) where the storage device 200 has been used up to now based on the state information received from the storage device 200 and reports a use suitable for the future as a recommended use based on the estimated information and statistics in the statistics server 20. For instance, when the storage device 200 has been used in a harsh environment in which write and erase operations are frequently performed as in a black box, the expected lifetime would be short and a use place such as a DSC in which a write operation is not frequent would be set for a recommended use in the future.

An OS in the OS/device driver 103 may be driven by the processor 110. The OS may manage resources (e.g., memory and computing power) of the electronic system 10a. The OS may distribute the resources to the applications 101. The OS may access hardware of the electronic system 10a at the request of the applications 101.

A device driver in the OS/device driver 103 may convert a hardware access request issued by the OS into a command that can be identified in hardware. For instance, the OS may issue a logic command for resource management and the device driver may convert the logic command into a physical command.

The storage device 200 may be accessed by an instruction output from the OS/device driver 103. The storage device 200 may be manufactured according to standard storage device specifications, e.g., SD card, MMC, eMMC or SSD specifications. These specifications permit vendor specific commands as well as normal commands. Normal commands may include a read command and a write command to perform common operations such as a read operation and a write operation. A vendor specific command is a command for which an operation is defined by a vendor or a manufacturer.

According to an exemplary embodiment of the inventive concept, a plurality of vendor specific commands such as a state information request, a configuration change command, and a selected operation execution command are defined to provide a method of optimizing the storage device 200 and the method can be performed by the vendor specific commands.

In an exemplary embodiment, the optimization application 102 issues a vendor specific command to the storage device 200 and receives a vendor specific response (e.g., a completion report which will be described later) from the storage device 200.

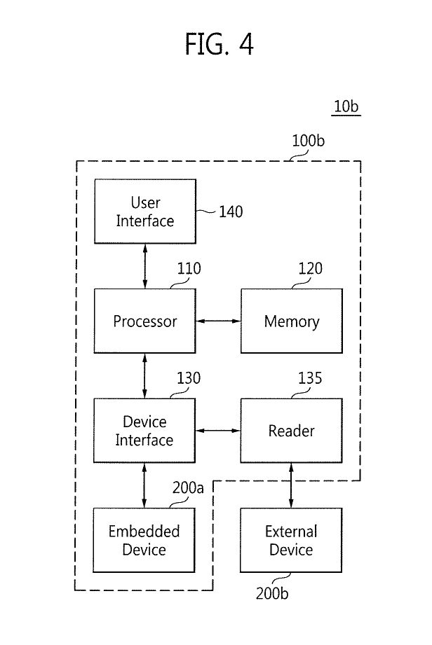

FIG. 4 is a block diagram of an electronic system 10b according to an exemplary embodiment of the inventive concept. Referring to FIG. 4, the electronic system 10b includes a host 100b and an external storage device 200b.

The host 100b includes the processor 110, the memory 120, the device interface 130, the user interface 140, a reader 135, and an embedded storage device 200a. The structure and operations of the electronic system 10b illustrated in FIG. 4 are similar to those of the electronic system 10a illustrated in FIG. 2. Thus, differences between the electronic system 10a and 10b will be described to avoid redundancy.

As compared with the electronic system 10a illustrated in FIG. 2, the electronic system 10b illustrated in FIG. 4 further includes the reader 135. In addition, the electronic system 10b includes both the embedded storage device 200a and the external storage device 200b.

The reader 135 may communicate with the processor 110 through the device interface 130. The reader 135 may control the external storage device 200b according to the control of the processor 110.

The external storage device 200b may communicate with the processor 110 through the device interface 130 as in the electronic system 10a illustrated in FIG. 2 and may communicate with the processor 110 through the reader 135 and the device interface 130 as in the electronic system 10b illustrated in FIG. 4. The reader 135 communicates with the device interface 130 according to a predetermined communication protocol. For instance, the reader 135 may communicate with the device interface 130 according to a universal serial bus (USB) protocol, but the inventive concept is not restricted to this example.

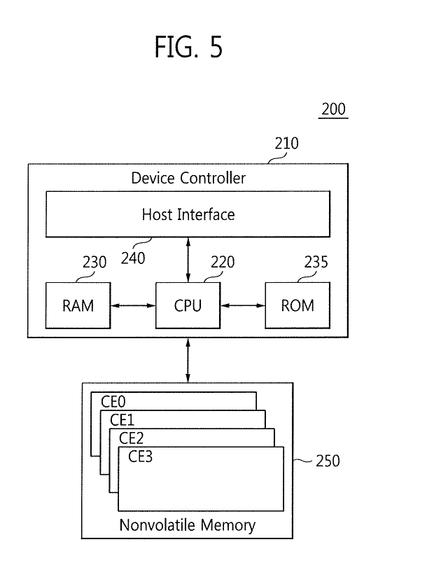

FIG. 5 is a schematic block diagram of a structure of the storage device 200 according to an exemplary embodiment of the inventive concept. Referring to FIG. 5, the storage device 200 includes a device controller 210 and a non-volatile memory 250.

The device controller 210 controls data communication between the host 100a or 100b (hereinafter, generically denoted by reference numeral 100) and the non-volatile memory 250. The device controller 210 includes a central processing unit (CPU) 220, a RAM 230, a ROM 235, and a host interface 240.

The CPU 220 controls the overall operation of the storage device 200. The CPU 220 may access the non-volatile memory 250 in response to a command and an address received through the host interface 240.

The RAM 230 may be an operation memory of the CPU 220. The RAM 230 may be buffer memory or cache memory. The RAM 230 may include volatile or non-volatile RAM such as SRAM, DRAM, SDRAM, FRAM, PRAM, MRAM, or PRAM.

The ROM 235 may store a ROM code. The ROM code may be first executed when the storage device 200 is powered up.

The host interface 240 may relay communications to the host 100. The host interface 240 may receive a command issued from the host 100, interpret the command, and generate a response according to the interpretation result. The host interface 240 may also receive data from or transmit data to the host 100 according to the command.

It is assumed that the non-volatile memory 250 is NAND flash memory in the current embodiments. However, the inventive concept is not restricted to the current embodiments and the non-volatile memory 250 may include FRAM, PRAM, MRAM, RRAM, or EEPROM. The non-volatile memory 250 may include a plurality of memory elements CE0 through CE3.

The non-volatile memory 250 may also include a plurality of memory blocks.

In an embodiment of the present inventive concept, the non-volatile memory 250 includes a three dimensional (3D) memory array. The 3D memory array is monolithically formed in one or more physical levels of arrays of memory cells having an active area disposed above a silicon substrate and circuitry associated with the operation of those memory cells, whether such associated circuitry is above or within such substrate. The term “monolithic” means that layers of each level of the array are directly deposited on the layers of each underlying level of the array.

In an embodiment of the present inventive concept, the 3D memory array includes vertical NAND strings that are vertically oriented such that at least one memory cell is located over another memory cell. The at least one memory cell may comprise a charge trap layer.

The following patent documents, which are hereby incorporated by reference, describe suitable configurations for three-dimensional memory arrays, in which the three-dimensional memory array is configured as a plurality of levels, with word lines and/or bit lines shared between levels: U.S. Pat. Nos. 7,679,133; 8,553,466; 8,654,587; 8,559,235; and US Pat. Pub. No. 2011/0233648.

The non-volatile memory 250 may be divided into a user area which a user can write data to or read data from and a non-user area which cannot be used by a user. For example, a user may be prevented from writing data to or reading data from the non-user area. A flash translation layer (FTL) meta data may be stored in the non-user area. Meta data is managed by the device controller 210 to run the storage device 200. The meta data may include state information of the storage device 200 and other data necessary for device operation, for example, a mapping table, data used in an algorithm for performance enhancement, a bad block management table, and an erase count.

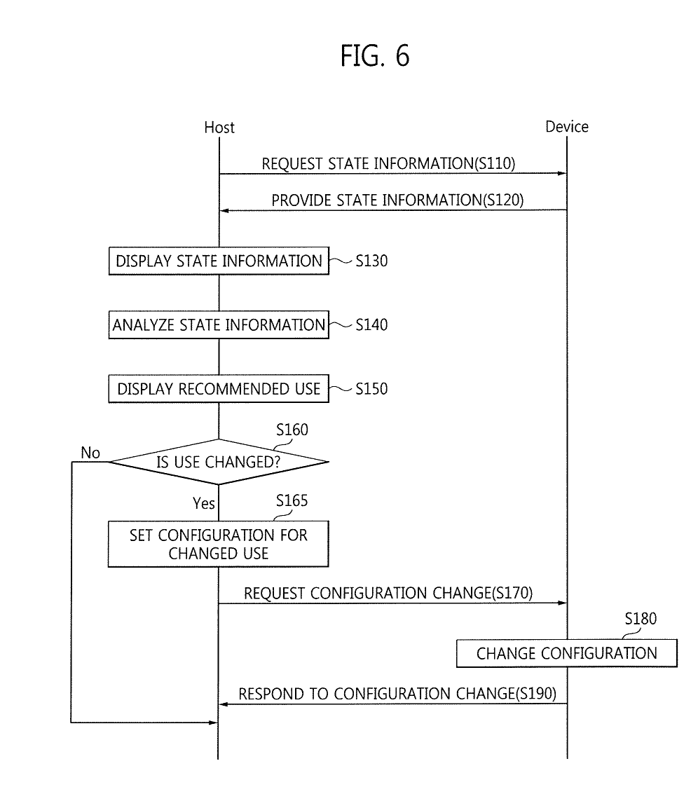

FIG. 6 is a flowchart of a method of optimizing a storage device according to an exemplary embodiment of the inventive concept. The method illustrated in FIG. 6 may be performed in the electronic system 10a or 10b (generically denoted by reference numeral 10) illustrated in FIG. 2 or 4.

Referring to FIG. 6, the optimization application 102 in the host 100 requests state information of the storage device 200 in operation S110 and reads the state information from the storage device 200 in operation S120. The requesting of the state information may be performed when the optimization application 102 is executed in the host 100 at a predetermined time (e.g., when the storage device 200 is booted or reset). Alternatively, after a user is allowed to select whether to request the state information, the requesting of the state information may be performed when the user selects an option to request the state information.

An example of the state information of the storage device 200 is illustrated in Table 1, in which the state information includes static state information and dynamic state information.

TABLE 1

| | Characteristics | | | | | |
|---|---|---|---|---|---|---|
| | Static state information | | | | Dynamic state information | |
| | LSB | Mapping | Over-provision | NAND | Average erase | |
| Information | backup | Mode | Ratio | type | count | WAI |
| Examples | O, X | Page | 2% | SLC, MLC, | 100 | 1 |
| | | Block | 3% | TLC | 200 | 7 |
| | | Hybrid | | | | |

The static state information is related with FTL architecture and can be changed, but its attribute is not changed until the end of lifetime once it is set. The dynamic state information is changed according to a use pattern and can be changed according to an environment in which a user uses the storage device 200.

An initial value of the static state information is a predetermined valid value and an initial value of the dynamic state information is an invalid value. When the host 100 initially recognizes the storage device 200, there is no valid value of the dynamic state information. However, the host 100 can recognize a current configuration of the storage device 200 based on the static state information.

The static state information may include least significant bit (LSB) backup support information, mapping mode information, over-provision ratio information, and NAND type information, but the inventive concept is not restricted to the current embodiments. The static state information may also include cache on/off information in other embodiments.

The LSB backup support information indicates whether the storage device 200 supports LSB backup. When data is written to upper bits of a block, in certain cases, the least significant bits may become corrupted. Accordingly, when the storage device 200 supports LSB backup, a memory controller of the storage device 200 may be configured to backup (i.e., copy) the LSB bits to another part of the storage device 200 prior to the upper bits being written. The mapping mode information indicates what mapping mode (e.g., page mapping mode, block mapping mode, or hybrid mapping mode) is used by the storage device 200. In the hybrid mapping mode, the storage device 200 uses both page mapping and block mapping. For example, in a hybrid mapping mode, data in one part of the storage device 200 is page mapped and data in a second part of the storage device 200 is block mapped. The over-provision ratio information indicates a ratio of a non-user area to an entire memory area of the non-volatile memory 250. For instance, when the entire memory area is 100 and a non-user area is set to 2, an over-provision ratio is 2%. For example, if the over-provision ratio is 2% and the size of the entire memory area is 1 million bytes, then the size of the non-user area is 20,000 bytes. The NAND type information indicates whether a memory cell is single-level cell (SLC), a multi-level cell (MLC), or a triple-level cell (TLC). SLC can store information corresponding to one bit, MLC can store information corresponding to two bits, and TLC can store information corresponding to three bits. The NAND type information may indicate whether memory cells are capable of storing single bits or multiple bits.

The dynamic state information may include average erase count information and write acceleration index (WAI) information. In an exemplary embodiment, the average erase count information indicates the average number of times each block in a number of blocks of the memory has been erased. In an exemplary embodiment, the WAI is a multiplication ratio of the data size actually written to a physical memory in comparison to the size of data that is intended to be written by the host system. The WAI may also be referred to as a write amplification factor. The WAI may be due to an internal operation, such as garbage collection and a wear-leveling process, and depend on a data workload pattern and the over-provisioning ratio.

When receiving the state information of the storage device 200, the host 100 may provide the state information for a user. The optimization application 102 may display the state information read from the storage device 200 to the user in operation S130.

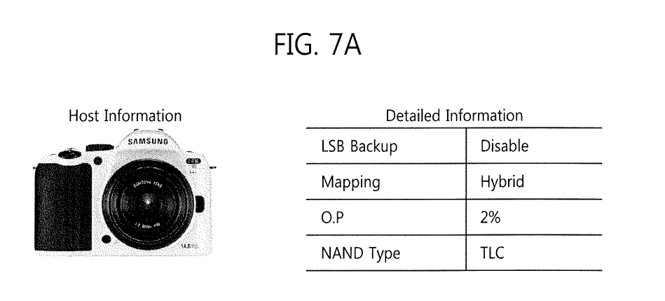

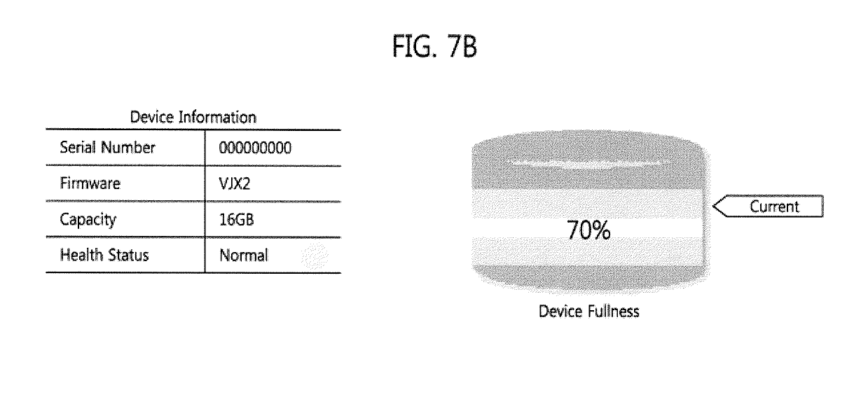

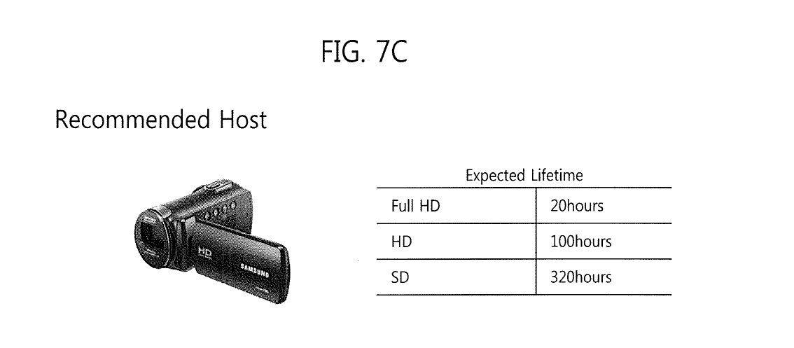

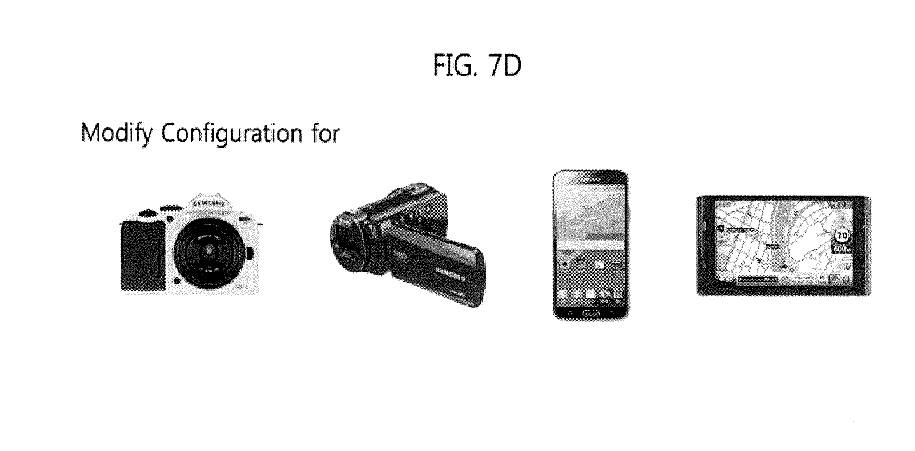

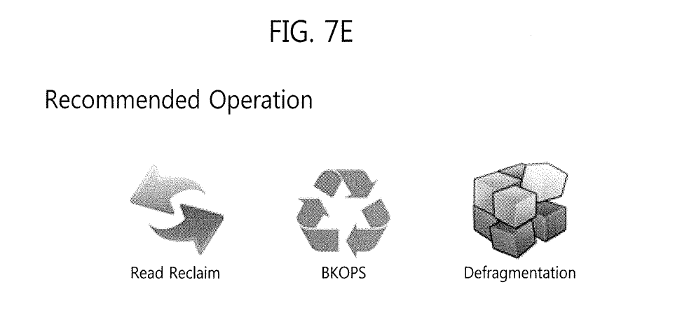

FIGS. 7A through 7E are diagrams of display screens of the optimization application 102 according to embodiments of the inventive concept. Referring to FIGS. 7A through 7E, the optimization application 102 may display current state information received from the storage device 200 through a display.

Referring to FIG. 7A, the optimization application 102 may display host information and current state information to a user. The current state information may include static state information such as LSB backup information, mapping mode information, over-provision ratio information, and NAND type information. In FIG. 7A, the LSB backup information indicates that a current LSB backup function has been disabled; the mapping mode information indicates that a current mapping mode is hybrid mapping mode; the over-provision ratio information indicates that a non-user area has been set to 2% of the entire memory area; and the NAND type information indicates that a NAND memory cell is a TLC.

The optimization application 102 may also display host (or use) information together with the current state information. The host information indicates a current use (or use place) of the storage device 200. In the embodiments illustrated in FIG. 7A, the storage device 200 is set for a use in a DSC.

Referring to FIG. 7B, the optimization application 102 may also display device information, for example, a serial number, firmware version, capacity and health status of the storage device 200. The optimization application 102 may also display a current device fullness of the storage device 200, i.e., a ratio (e.g., 70%) of an area in which data has been stored to the entire memory area.

The host 100 may analyze the state information of the storage device 200 in operation S140 and may determine and display a recommended use to the user in operation S150. In detail, the optimization application 102 may compare a result of analyzing the state information with statistics for each use stored in advance and may find a use best matching the analyzed result in operation S150.

For instance, when it is determined that the storage device 200 supports LSB backup and its NAND type is an MLC as a result of analyzing the state information of the storage device 200, a car navigation system (CNS), i.e., a black box requiring relatively high reliability may be a recommended use. Contrarily, when it is found that the storage device 200 does not support LSB backup and its NAND type is a TLC, a DSC or a DVC rather than a black box requiring high reliability may be a recommended use.

The optimization application 102 may display a “recommended use” or “recommended host” through a display, so that the user is allowed to select the recommended use in operation S160.

FIG. 7C shows a case where the recommended use is a DVC. At this time, the optimization application 102 displays a DVC as the recommended use (i.e., the recommended host) and allows the user to select the DVC. The optimization application 102 may also calculate and provide an expected lifetime for the user.

There is only one recommended host in the case shown in FIG. 7C, but there may be two or more recommended hosts in other cases. In such cases, the optimization application 102 may display the recommended hosts without priority information or may display a firstly recommended host and a secondly recommended host according to priority.

When one of the recommended uses displayed is selected by the user (i.e., in case of YES in operation S160), the optimization application 102 sets configuration corresponding to the selected use. As described above, the optimization application 102 may have predetermined configuration information for each use. Table 2 shows examples of configurations for each use.

TABLE 2

| | | Mapping | Over-provision | |
|---|---|---|---|---|
| Uses | LSB backup | mode | ratio | NAND type |
| DSC/DVC | Unnecessary | Block | Don't care | Don't care |
| Smart phone | Unnecessary | Page | 2% or higher | Don't care |
| CNS | Necessary | Don't care | Don't care | SLC or MLC |

Referring to Table 2, the optimization application 102 may have configuration for a CNS, configuration for a smart phone, and configuration for DSC/DVC in a table form. In other embodiments, the optimization application 102 may receive configuration predetermined for each use from the statistics server 20.

The optimization application 102 issues a configuration change request to the storage device 200 in operation S170. The configuration change request may include at least one vendor specific command.

The host 100 may issue a vendor specific command using a normal command and an address. For instance, the optimization application 102 may select a normal command and an address for a vendor specific command according to a predetermined rule. The optimization application 102 may issue the selected command and address to issue the vendor specific command. The CPU 220 may receive the normal command and the address through the host interface 240 and may access the non-volatile memory 250 based on the normal command and the address.

The storage device 200 changes the configuration of the non-volatile memory 250 in response to the configuration change request in operation S180. When the change is completed, the storage device 200 may transmit a change completion response to the host 100 in operation S190.

For instance, when the user selects the DSC/DVC, i.e., the recommended use illustrated in FIG. 7C, the optimization application 102 selects the configuration for DSC/DVC from predetermined configuration information as shown in Table 2 and issues the configuration change request to the storage device 200 to request to change a current configuration into the selected configuration. For instance, the optimization application 102 may request the storage device 200 to disable the LSB backup and to change the mapping mode into the block mapping mode according to the configuration for DSC/DVC. Since “don't care” is set for the over-provision ratio and the NAND type in the configuration for DSC/DVC, no change is necessary for the over-provision ratio and the NAND type.

According to the method illustrated in FIG. 6, the state information of the storage device 200 is analyzed, a user is informed of a recommended use, and the configuration of the storage device 200 is automatically changed according to a selected use. The method may be performed when a certain period of time elapses since the storage device 200 starts to be used or when a user wants to change the use of the storage device 200. However, the inventive concept is not restricted to these cases.

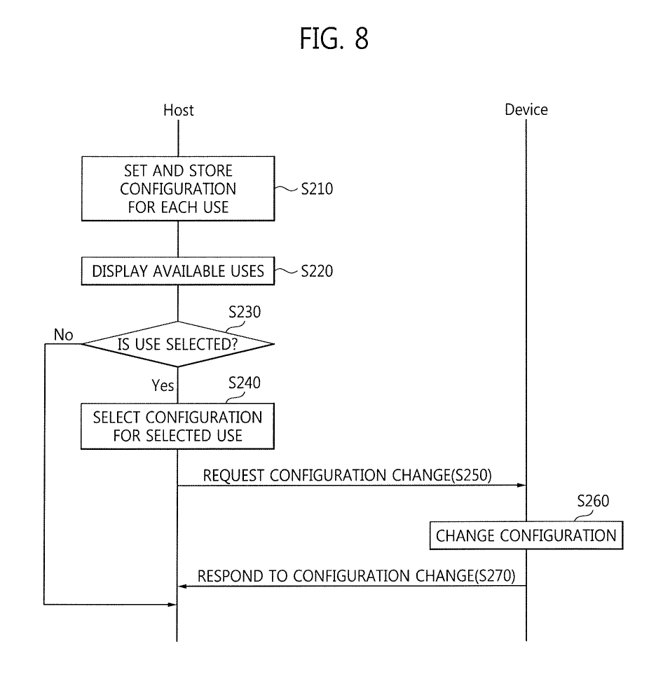

FIG. 8 is a flowchart of a method of optimizing the storage device 200 according to an exemplary embodiment of the inventive concept. The method illustrated in FIG. 8 may also be performed by the electronic system 10a or 10b illustrated in FIG. 2 or 4. The method illustrated in FIG. 8 may be performed to set the configuration of the storage device 200 to be suitable for a use before a user purchasing the storage device 200 starts to use the storage device 200, but the inventive concept is not restricted to this occasion. When some time elapses since the storage device 200 starts to be used or when the user wants to change the use of the storage device 200, the method illustrated in FIG. 8 may also be performed.

As described above, the optimization application 102 may have configuration information predetermined for each use in operation S210. When the optimization application 102 is executed in the host 100, the optimization application 102 displays available uses for a user in operation S220. Before operation S220, operations S110 through S140 illustrated in FIG. 6 may have been performed.

Referring to FIG. 7D, the optimization application 102 may display a graphical user interface (GUI) screen allowing “select use” or “change use” to be selected. For instance, the optimization application 102 may display a DSC, a DVC, a smart phone, and a CNS as uses of the storage device 200 to allow the user to select one from among the displayed uses in operation S220.

When it has been determined that the user has selected one from among the displayed uses in operation S230, the optimization application 102 selects a configuration for the selected use in operation S240. The optimization application 102 issues a configuration change request to the storage device 200 in operation 5250. The configuration change request may include at least one vendor specific command.

The storage device 200 changes or modifies the configuration of the non-volatile memory 250 in response to the configuration change request in operation S260. When the change is completed, a change completion response is transmitted to the host 100 in operation S270.

For instance, when the CNS is selected from among the uses illustrated in FIG. 7D, the optimization application 102 selects the configuration for CNS from the configuration information predetermined for each use, as shown in Table 2, and issues the configuration change request to the storage device 200 to request to change the current configuration into the selected configuration. For example, the optimization application 102 may issue an LSB backup enable command to enable the LSB backup according to the configuration for CNS. The storage device 200 may set a register related with the LSB backup in response to the LSB backup enable command and may perform backup of an LSB page at predetermined intervals.

Since “don't care” is set for the mapping mode and the over-provision ratio in the configuration for CNS, no change is necessary for the mapping mode and the over-provision ratio. However, the inventive concept is not restricted thereto. The optimization application 102 may issue a mapping change command and an over-provision change command to modify the configuration of the storage device 200 to be suitable for the selected use.

The storage device 200 may change a current mapping mode into a mapping mode (e.g., block mapping, page mapping, or hybrid mapping) corresponding to the mapping change command and change a current over-provision ratio into a ratio corresponding to the over-provision change command. For this operation, the storage device 200 may perform erasing and/or merging of at least one memory block.

In an exemplary embodiment, commands issued by the optimization application 102 to modify or optimize the configuration of the storage device 200 are predetermined vendor specific commands.

According to an exemplary embodiment of the inventive concept, a user is allowed to optimize the configuration of the storage device 200 for the purpose of use selected after the user purchases the storage device 200. In addition, when the user wants to change the purpose of use after having used the storage device 200, the user is allowed to optimize the configuration of the storage device 200 to be suitable for the new purpose of use.

For instance, when the user has the storage device 200 optimized for a DSC and wants to use the storage device 200 for a CNS, the user can select the CNS on the “change use” GUI screen (i.e., a “Modify configuration for” screen) illustrated in FIG. 7D. Then, a request to change the configuration of the storage device 200 to be suitable for the CNS is transmitted to the storage device 200 and the configuration of the storage device 200 is changed into the configuration for the CNS as shown in Table 2.

In another instance, an external storage device such as an SD card can be used for various purposes in various hosts and a used SD card may be used in a newly purchased host. According to an exemplary embodiment of the inventive concept, it can be detected based on the state information of the SD card whether the SD card can be used in the new host (i.e., whether the new host is a recommended use of the SD card) or how long the SD card can be used in the new host (i.e., an expected lifetime of the SD card).

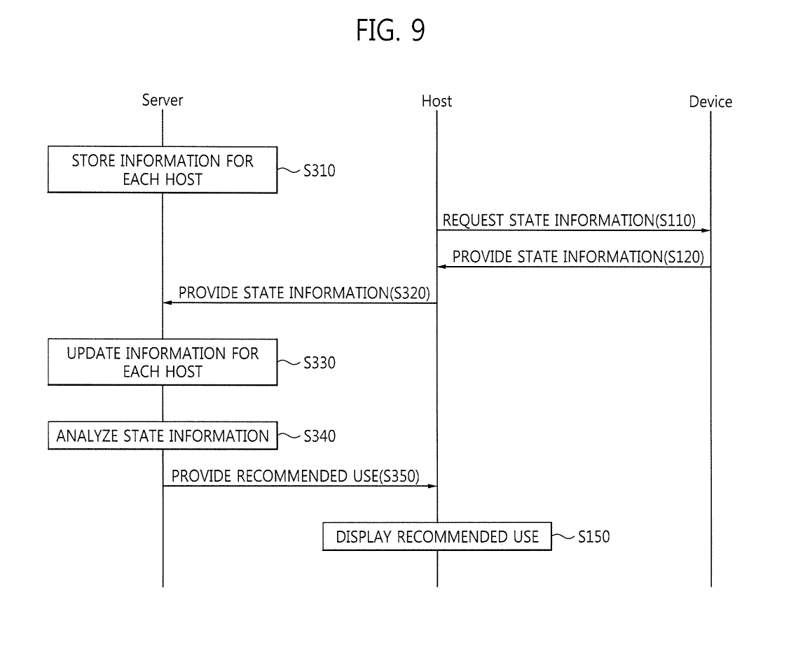

FIG. 9 is a flowchart of a method of optimizing the storage device 200 according to an exemplary embodiment of the inventive concept. The method illustrated in FIG. 9 may also be performed by the electronic system 10a or 10b illustrated in FIG. 2 or 4. The method illustrated in FIG. 9 is similar to that illustrated in FIG. 6. Thus, differences between two methods will be described to avoid redundancy.

In the method illustrated in FIG. 6, the optimization application 102 analyzes the state information of the storage device 200 and determines a recommended use based on the current state of the storage device 200. However, in the method illustrated in FIG. 9, the statistics server 20 stores configuration information for each use or host in operation S310 and the optimization application 102 provides the state information for the statistics server 20 in operation 5320 and receives a recommended use from the statistics server 20 in operation S350.

The statistics server 20 collects state information of the storage device 200 received from the host 100 to change or update configuration information initially set for each use in operation S330. The statistics server 20 also analyzes the state information of the storage device 200 received from the host 100 in operation S340 and determines a use or host most suitable to the current state of the storage device 200. The host 100 is informed of the determined use in operation S350.

After operation S150, operations S160 through S190 illustrated in FIG. 6 may be performed in the method illustrated in FIG. 9.

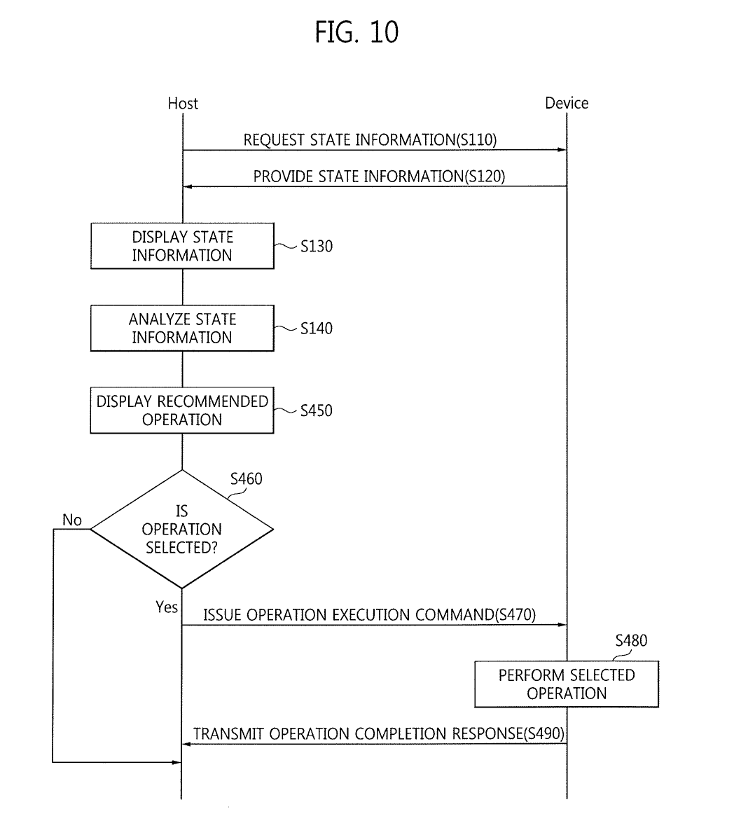

FIG. 10 is a flowchart of a method of optimizing the storage device 200 according to an exemplary embodiment of the inventive concept. The method illustrated in FIG. 10 may also be performed by the electronic system 10a or 10b illustrated in FIG. 2 or 4. The method illustrated in FIG. 10 is similar to that illustrated in FIG. 6. Thus, differences between two methods will be described to avoid redundancy.

In the method illustrated in FIG. 10, the optimization application 102 displays recommended operations which will be helpful in a current state of the storage device 200 based on the state information of the storage device 200 in operation S450. Referring to FIG. 7E, the optimization application 102 displays a read reclaim operation, a background operation BKOPS, and defragmentation as the recommended operations in operation S450.

When a user selects one of the recommended operation (in case of YES) by clicking on a corresponding icon in operation S460, the optimization application 102 issues an operation execution command to the storage device 200 in operation S470. The storage device 200 performs the selected operation in response to the operation execution command in operation S480. When the operation is completed, the storage device 200 transmits an operation completion response to the host 100 in operation S490.

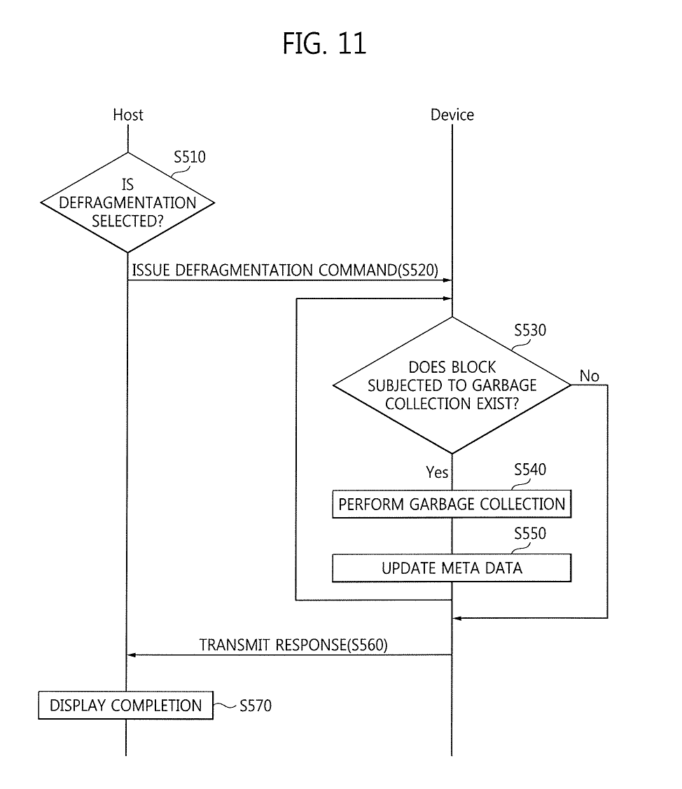

FIG. 11 is a flowchart of operations when defragmentation is selected in the method illustrated in FIG. 10. When the user selects the defragmentation from among the recommended operations illustrated in FIG. 7E (in case of YES) in operation S510, the optimization application 102 issues a defragmentation command to the storage device 200 in operation 5520 and the storage device 200 performs defragmentation in response to the command in operations 5530 through S550.

In defragmentation, whether a block subjected to garbage collection exists is checked in operation 5530. When a block subjected to garbage collection exists, garbage collection is performed in operation S540 and meta data is updated in operation S550. Defragmentation may be carried out by performing garbage collection until there is no more block subjected to garbage collection.

After completing defragmentation, the storage device 200 may transmit an operation completion response to the host 100 in operation S560. The optimization application 102 may display that defragmentation has been completed to the user in operation S570.

According to an exemplary embodiment of the invention, a method for reconfiguring an NVM includes: the NVM sending state information of the NVM in response to receipt of a first command requesting state information; and the NVM adjusting its configuration to one that is optimized for a host device of a certain type in response to receipt of a second command requesting configuration of the NVM for the type. For example, the host 100 may send the first command to the storage device 200. The storage device 200 is configured to respond to the first command with the state information, which may include one or more pieces of information of the above-described static state information and dynamic state information. The host 100 is configured to analyze the received state information to determine which host device from among a plurality of different types (e.g., DSC, DVC, smartphone, etc.) is best suited to use the storage device 200. The host 100 then formats the second command with configuration information that the storage device 200 can use this information to re-configure itself so it can use perform better with host devices of the determined type, and sends the second command to the storage device 200. The storage device 200 is configured to interpret the second command and re-configure itself in response to the second command and the information stored within the second command. For example, the information in the second command may indicate that the storage device 200 should perform at least one of enabling/disabling LSB backup, changing of its over-provision ratio to a particular value, changing its mapping mode (e.g., page/block/hybrid), or configuring how much data its cells will store (e.g., SLC/MLC).

As described above, according to an exemplary embodiment of the inventive concept, a user is informed of a recommended use based on state information of a storage device and the configuration of the storage device is automatically changed to be suitable for a use selected by the user. In addition, user convenience is increased using an application program executed in a host. Therefore, when a user changes a use (or a host) of a storage device, and more particularly, an external storage device; the storage device can be optimized for the changed use or host.

While the inventive concept has been particularly shown and described with reference to exemplary embodiments thereof, it will be understood by those of ordinary skill in the art that various changes in forms and details may be made therein without departing from the spirit and scope of the inventive concept.

What is claimed is:

1. A method of optimizing a storage device including a non-volatile memory using an application program of a host, the method comprising:
requesting, by the application program, state information from the storage device;
analyzing, by the application program, the state information received in response to the requesting to determine at least one recommended use for the storage device;
displaying, by the application program, the at least one recommended use to a user to enable the user to select a recommended use;
setting, by the application program, a configuration corresponding to the selected use; and
issuing, by the application program, a configuration change request to the storage device to configure the storage device with the set configuration.

2. The method of claim 1, further comprising storing predetermined configuration information for each of a plurality of uses.

3. The method of claim 2, wherein the determining the at least one recommended use comprises comparing a result of analyzing the state information with the configuration information for each of the uses.

4. The method of claim 2, further comprising receiving, by the application program, the configuration information for each of the uses from a server through a network.

5. The method of claim 2, wherein the configuration change request comprises at least one vendor specific command.

6. The method of claim 1, further comprising:
displaying, by the application program, recommended operations to the user; and
issuing, by the application program, an operation execution command to the storage device when one of the recommended operations is selected by the user.

7. The method of claim 6, wherein the recommended operations comprise a defragmentation operation, a background operation, and a read reclaim operation.

8. The method of claim 1, wherein the state information comprises static state information and dynamic state information;
the static state information comprises at least one among least significant bit (LSB) backup support information, mapping mode information, over-provision ratio information, and NAND type information; and
the dynamic state information comprises at least one among average erase count information and write acceleration index (WAI) information.

9. The method of claim 2, wherein the configuration change request comprises at least one command among a command to enable or disable least significant bit (LSB) backup, a command to change a mapping mode, a command to change a ratio of a non-user area to an entire memory area of the non-volatile memory, and a command to change a memory type.

10. A method of optimizing a storage device including a non-volatile memory using an application program of a host, the method comprising:
storing, by the application program, configuration information for each of a plurality of uses of the storage device;
displaying, by the application program, a subset of the uses to a user to enable the user to select a use;
selecting, by the application program, a configuration corresponding to the selected use from among the configuration information;
issuing, by the application program, a configuration change request to the storage device according to the selected configuration; and
changing, by the storage device, a configuration of the non-volatile memory in response to the configuration change request.

11. The method of claim 10, further comprising the application program requesting state information from the storage device, wherein the subset is determined based on the state information.

12. The method of claim 11, further comprising:
displaying, by the application program, at least one recommended operation to the user based on the state information; and
issuing, by the application program, an operation execution command to the storage device when one of the at least one recommended operation displayed is selected by the user.

13. The method of claim 12, wherein the at least one recommended operation comprises a defragmentation operation, a background operation, and a read reclaim operation.

14. The method of claim 13, further comprising:
issuing, by the application program, a defragmentation command on the storage device when the defragmentation operation is selected; and
performing garbage collection in the storage device in response to the defragmentation command until there is no more block subjected to garbage collection among memory blocks of the storage device.

15. The method of claim 12, wherein the configuration change request and the operation execution command comprise at least one vendor specific command.

16. A method for reconfiguring a non-volatile memory (NVM), the method comprising:
sending, by a NVM, state information of the NVM in response to receipt of a first command requesting state information; and
adjusting, by the NVM, a configuration of the NVM to a configuration optimized for a host device of a type in response to receipt of a second command requesting configuration of the NVM for the type.

17. The method of claim 16, wherein the second command enables or disables a least significant bit (LSB) backup of the NVM.

18. The method of claim 16, the second command changes a ratio of a non-user area of the NVM to an entire memory area of the NVM.

19. The method of claim 16, wherein the second command changes a mapping mode of the NVM to one of a page mapping mode, a block mapping mode, and a hybrid mapping mode.

20. The method of claim 16, wherein the second command configures memory cells of the NVM to one of single level cells and multi-level cells.
